(19) United States
(12) Patent Application Publication
(10) Pub. No.: US 2019/0311248 A1
(43) Pub. Date: Oct. 10, 2019

(54) METHOD FOR RANDOM SAMPLED CONVOLUTIONS WITH LOW COST ENHANCED EXPRESSIVE POWER

(71) Applicant: Intel Corporation, Santa Clara, CA (US)

(72) Inventors: Shahar Fleishman, Hod Hasharon (IL); Raizy Kellermann, Jerusalem (IL); Rana Hanocka, Tel Aviv (IL)

(73) Assignee: Intel Corporation, Santa Clara, CA (US)

(21) Appl. No.: 16/448,355

(22) Filed: Jun. 21, 2019

(51) Int. Cl. G06N 3/04; G06N 3/08; G06K 9/62; G06F 9/38; G06F 9/30

(52) U.S. Cl. CPC G06N 3/0454; G06N 3/082; G06F 9/30036; G06F 9/3887; G06K 9/6256

(57) ABSTRACT

A system and method for random sampled convolutions are disclosed to efficiently boost a convolutional neural network (CNN) expressive power without adding computation cost. The method for random sampled convolutions selects a receptive field size and generates filters with a subset of the receptive field elements, the number of learnable parameters, as being active, wherein the number learnable parameters corresponds to computing characteristics, such as SIMD capability, of the processing system upon which the CNN is executed. Several random filters may be generated, with each being run separately on the CNN. The random filter that causes the fastest convergence is selected over the others. The placement of the random filter in the CNN may be per layer, per channel, or per convergence operation. The CNN employing the random sampled convolutions method performs as well as other CNNs utilizing the same receptive field size.

### BACKGROUND

Convolutional neural networks (CNNs) are currently the state of the art in many tasks in the computer vision field. The expressive power of neural networks often depends on the computation power, which may be increased by either creating a deeper network or by enlarging the number of the channels for the existing layers.

CNNs have a high computational cost of evaluation, with convolutional layers usually taking up over 80% of the time. The computational requirements of CNNs hinder their use in systems without GPUs and where power is a consideration, such as mobile devices.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a simplified block diagram of a device including an SIMD-capable multi-processor for implementing random sampled convolutions, in accordance with some embodiments.

FIG. 2 is a simplified block diagram of a random sampled convolutions method, in accordance with some embodiments.

FIG. 3 is a simplified block diagram contrasting single instruction single data (SISD) processing with SIMD processing, in accordance with some embodiments.

FIG. 4 is an illustration of an SIMD configuration that may be exploited by the random sampled convolutions method of FIG. 2, in accordance with some embodiments.

FIG. 5 is an illustration of a random sampled convolution, in accordance with some embodiments.

FIG. 6 is an illustration of a randomized filter generated by the random sampled convolutions method of FIG. 2, in accordance with some embodiments.

FIG. 7 is a flow chart illustrating the random sampled convolutions method of FIG. 2, in accordance with some embodiments.

FIG. 8 is a loss/accuracy plot for three different CNNs, including a CNN generated by the random sampled convolutions method of FIG. 2, using the MNIST database, in accordance with some embodiments.

FIG. 9 is a loss/accuracy plot for three different CNNs, including a CNN generated by the random sampled convolutions method of FIG. 2, using the CIFAR10 database, according to some embodiments.

FIG. 10 is an illustration of an exemplary computing architecture comprising for implementing the random sampled convolutions method of FIG. 2, according to some embodiments.

### DETAILED DESCRIPTION

The present disclosure provides a computing system having a single instructions, multiple data (SIMD) capable processor and a CNN arranged to be executed on the computing system. Also disclosed is a method for random sampled convolutions. The method may include selecting a receptive field size and generating filters with a subset of the receptive field elements, known as the number of learnable parameters. The number of learnable parameters may correspond to computing characteristics, such as the capability of the SIMD processor of the computing system on which the CNN is being executed. Several filters may be generated, for example, randomly. Each filter may be executed on the CNN and the time to convergence may be measured. The filter corresponding to the fastest convergence may be selected. In some examples, filters may be generated and selected as described herein for each layer of the CNN, each channel of the CNN, or for each convergence operation of the CNN.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. In other instances, well-known structures, materials, or operations are not shown or described in detail to avoid obscuring aspects of the disclosure. The following detailed description is, therefore, not to be construed in a limiting sense, as the scope of the subject matter is defined by the claims.

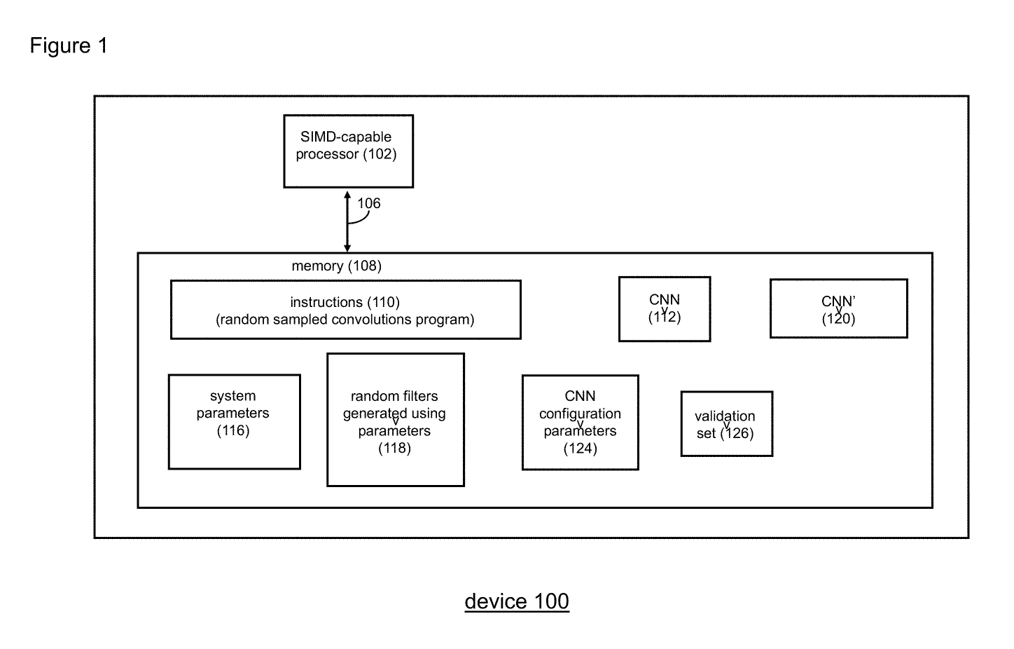

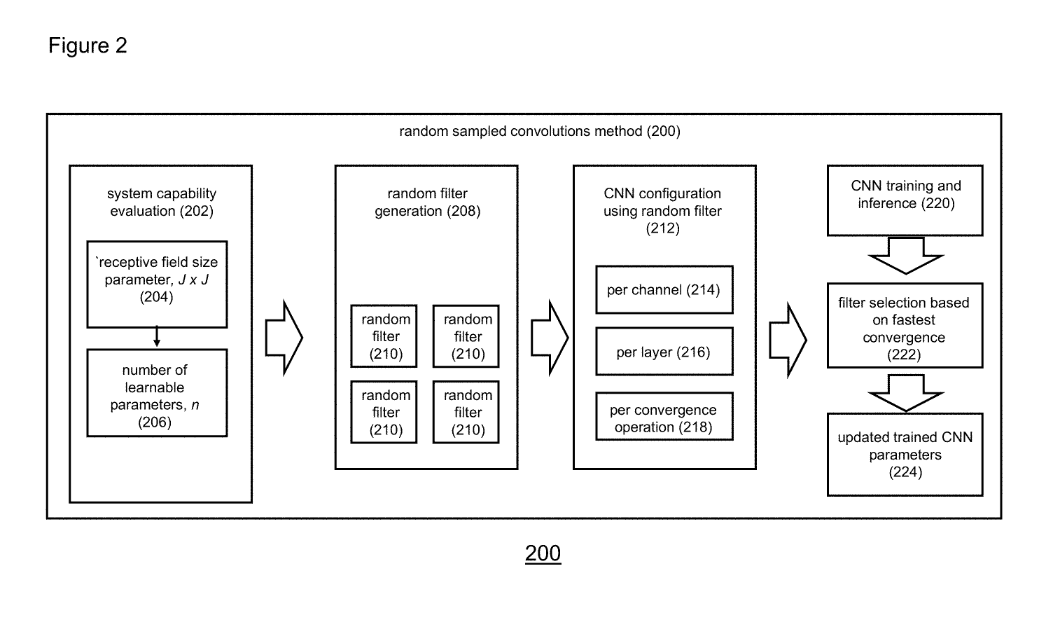

FIGS. 1 and 2 are simplified block diagrams of a device 100 and a method 200, respectively, for random sampled convolutions, according to some embodiments. Although FIGS. 1 and 2, and particularly, device 100 and method 200, are described in conjunction with each other, device 100 may be implemented and arranged to implement random sampled convolutions using a different method than is described in FIG. 2 while the method 200 may be implemented by a device different than that described in FIG. 1. The description is not limited in this respect. Also, as the device 100 is arranged to implement random sampled convolutions (e.g., via implementation of method 200), device 100 may be referred to herein as a system under test (SUT).

In FIG. 1, the device 100 includes a processor 102, which is arranged to execute a Single Instruction, Multiple Data (SIMD) instruction set (not shown). Processor 102 may be circuitry, arranged to execute instructions. Processor 102 may be a commercial processor and may include multiple cores.

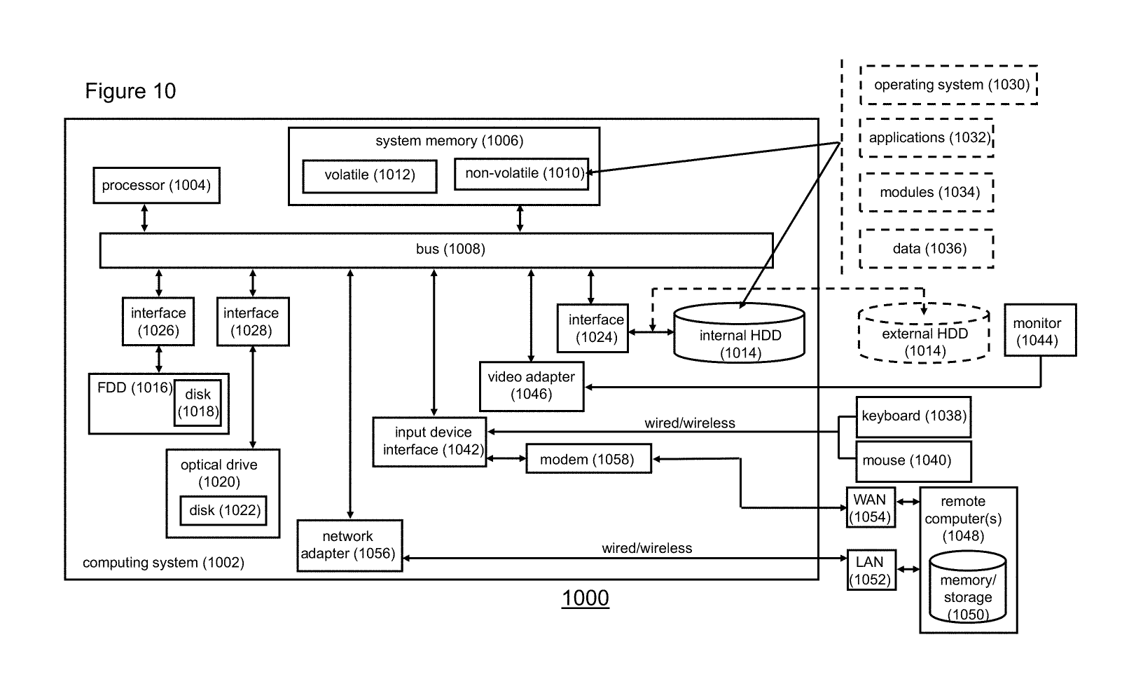

Device 100 further includes memory 108 coupled to the processor 102 via bus 106. The memory 108 may be based on any of a variety of types of memory circuitry, numerous examples of which are provided in conjunction with FIG. 10.

The memory 108 includes instructions 110, which are executable by the processor 102. Instructions may be referred to herein as a “random sampled convolutions program” for convenience. The memory 108 further includes CNN 112, system parameters 116, filters 118, CNN′ 120, parameters 124, and a validation set 126.

Generally, device 100 (particularly processor 102) may execute instructions 110 to boost the expressive power of a CNN without burdening the computation cost. As noted, device 100 includes a SIMD-capable processor 102, which is a processor that is able to execute a Single Instruction, Multiple Data (SIMD) instruction set. The processor 102 is connected to memory 108 by bus 106, which may be a memory bus, a Peripheral Component Interconnect (PCI) bus, or the like.

Processor 102, in executing instructions 110, leverages system parameters 116, which are tailored to the SIMD characteristics of the device 100, and particularly processor 102. Processor 102, in executing instructions 110, may generate filters 118 having characteristics that exploit the SIMD characteristics of the device. Filters 118 may be used in one or more portions of the CNN 112. Training and inference of CNN 112 using validation set 126 may be performed separately using CNN 112 with filters 118. The combination of CNN 112 and the filter 118 that converges first may be selected, resulting in CNN′ 120 with optimized performance characteristics. A CNN parameters 124 may be updated to include the filter 118 associated with the combination that converged first. In some embodiments, the CNN′ 120 performs as well as those utilizing higher computing costs.

In general, validation set 126 may be any testing/training data set for CNN 112. For example, in the context of image processing, the validation set 126 may be a set of images used to compute the accuracy or error of the CNN. There are many databases of images that may be used, as training sets (used to train the CNN), as validation sets, and as test sets. It is noted that, although validation set 126 is depicted stored in memory 108, the validation set may be hosted on a separate memory (e.g., external device, cloud storage location, etc.) and may be accessed by the device 100 via a network.

FIG. 2 is a simplified block diagram of a random sampled convolutions method 200, according to some embodiments. The method 200 may be implemented by the device 100 (FIG. 1), or another SIMD-capable device. For example, processor 102 of device 100 may execute instructions 110 to implement operations associated with method 200. The random sampled convolutions method 200 performs system capability evaluation 202, random filter generation 208, and updates a CNN using the random filters 212. From the updated CNN, training and inference of the CNN 220 are performed, a filter selection is made based on the fastest convergence 222, and the trained CNN parameters are updated 224.

In some embodiments, the system capability evaluation 202 determines two parameters based on characteristics of the SIMD-capable device upon which the CNN is to be run. First, a receptive field size 204 is determined. Generally, the receptive field is a square and its size 204 is given by J×J, for integer J. From the receptive field, a number of learnable parameters, n, 206, for integer, n, is determined. In particular, the number of learnable parameters 206 is selected based on the SIMD characteristics of the device upon which the infererence model will be run. In some embodiments, the number of learnable parameters 206 is selected based on non-SIMD characteristics of the device upon which the CNN will be run. For example, SIMD within a register, known as SWAR, is a range of techniques used to perform SIMD in general-purpose registers on hardware that does not provide direct support for SIMD instructions.

Once the parameters 204 and 206 have been determined, a random filter generator 208 generates one or more random filters 210 based on the parameters. These filters 210 each separately become part of the CNN configuration 212 and, in some embodiments, are compared to one another. Each filter may be used in different parts of the CNN, whether per channel 214, per layer 216, or for each convergence operation 218. In some embodiments, the method 200 uses different random filters in a single convolution layer, with each layer learning K filters for integer, K, and each filter being randomly sampled. The CNN then goes through training and inference 220. If there are four random filters 210, then, in some embodiments, four separate CNNs, each one being configured with one or more of each different random filter, go through training and inference. Whichever of these filters causes the CNN to converge the fastest is the one selected 222, and the updated trained CNN parameters 224 are saved.

Before describing the system for random sampled convolutions (FIG. 1) and the method for random sampled convolutions (FIG. 2) in more detail, a general discussion of convolutional neural networks and SIMD architecture, are provided.

Convolutional Neural Networks

A convolutional neural networks (CNN) is a class of deep neural networks that are most commonly used to analyze visual images. CNNs were inspired by the way an animal's brain neurons respond to stimuli in but a portion of the visual field, known as the receptive field. Different neurons have partially overlapping receptive fields, such that, together, the neurons are able to perceive the entire visual field.

A CNN consists of an input layer, multiple hidden layers, and an output layer. Another way to think of a CNN is as having a feature learning part and a classification part. The hidden layers (or feature learning layers) may include one or more of a convolution layer, a ReLU layer, short for rectified Linear Unit (an activation layer), and a pooling layer. In the classification part, there is a fully connected layer, which flattens out the output from previous layers into a vector. The fully connected layer is designed to harness the learning that has been done in the previous layers. Finally, a SoftMax function is applied to the fully connected layer, resulting in a set of probability values, indicating the probability that the input image is one of a specific class of outputs.

The pooling layer generally shrinks the image stack. Max pooling, for example, takes the maximum of its neighbors, while average pooling takes the average of its neighbors. Pooling reduces the size of the activations that are fed to the next layer, which reduces the memory footprint and improves the overall computational efficiency. The ReLU layer changes negative values to zero. The ReLU layer acts as an activation function, ensuring non-linearity as the image data moves through each layer in the network.

CNNs are generally defined as multiples of these different layers, and the layers are often repeated. For example, a CNN can be defined a series of convolutional blocks, such as convolution→ReLU→convolution→ReLU→pooling→convolution→ReLU→pooling. Each time, as the image goes through convolution layers, it gets more filtered, and it gets smaller as it goes through pooling layers. In the fully connected layer, a list of feature values becomes a list of votes. Fully connected layers can also be stacked together.

Each layer of the CNN contains neurons (usually depicted as circles). Unlike in regular neural networks, a neuron is not connected to every other neuron in the previous layer, but only to neurons it its vicinity. The CNN is trained using a training set of input data. So, for image processing, the input data is a bunch of labeled images. After training is complete, the CNN is supposed to be able to receive a new, unlabeled image, and correctly determine what the image is, a process known as inference.

The term convolution refers to the filtering process that happens at the convolution layer. The convolution layer takes a filter (also called a kernel) over an array of image pixels. This creates a convolved feature map, which is an alteration of the image based on the filter. In the convolutional layer, a convolution is applied to the input using a receptive field. The receptive field is usually a square, such as, for example, 3×3 pixels or 5×5 pixels. The convolution layer receives input from a portion of the previous layer, where the portion is the receptive field, and applies a filter to the receptive field, to find features of an image. The convolution is the repeated application of the filter over the receptive field.

The features in the convolutional layers and the voting weights in the fully connected layers are learned by backpropagation. The voting weights can thus be set to any value initially. For each feature pixel and voting weight, adjustments up and down are made to see how the error changes. The error signal helps drive a process known as gradient descent. The ability to do gradient descent is very special feature of CNNs. Each of the feature pixels and voting weights are adjusted up and down by a very small amount to see how the error changes. The amount they're adjusted is determined by how big the error is. Doing this over and over helps all of the values across all the features and all the weights settle in to a minimum. At that point, the network is performing as well as it can.

CNNs can operate on multiple channels of data at a time. A color image, for example, is usually stored in a computer as three channels of data, one for Red, one for Blue, and one for Green. The value of each pixel in an image is thus actually three values, each from 0-255, where the Red value indicates, “the amount of redness” of the pixel, the Green value indicates, “the amount of greenness” of the pixel, and the Blue value indicates, “the amount of blueness” of the pixel. CNNs process each of these channels independently.

Hyperparameters are parameters that are not learned automatically by the network, but are set in advance by the CNN designer. How many of each type of layer should be used, the order of the layers, how many features should be used, how many neurons are in each layer, the window size and stride for the pooling layer, the number of hidden and intermediate neurons, are among the parameters decided by the CNN designer.

There are some common practices that tend to work better than others, but there are no hard-and-fast rules for the correct way to design a CNN. Many advances in CNNs result from designing combinations of hyperparameters that cause the CNN to converge to a correct answer quickly. In the method 200, for example, the receptive field size parameter 204 and the number of learnable parameters 206 in FIG. 2 are hyperparameters.

SIMD Architecture

Single Instruction, Multiple Data (SIMD) describes computers with multiple processing elements that perform the same operation on multiple data points simultaneously. SIMD is particularly applicable to certain tasks, like adjusting the contrast of a digital image. A processor performs its job, executing instructions, using specific instructions known to the processor. For example, there is an x86 instruction set for Intel's x86 processors. There are also instruction set extensions, such as Streaming SIMD Extensions (SSE), which enable the processor to execute a single instruction on multiple pieces of data simultaneously. Many SIMD instructions are available via these instruction set extensions.

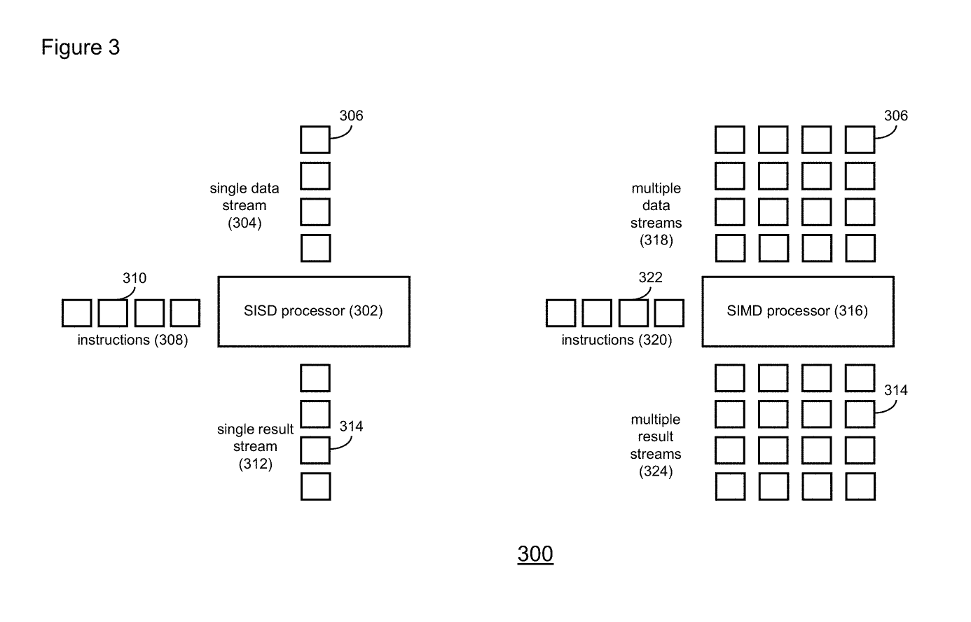

FIG. 3 is a simplified block diagram 300 contrasting single instruction single data (SISD) processing with SIMD processing, according to some embodiments. With a SISD processor 302, a single data stream 304 includes four distinct data elements 306, arriving at the processor, one after another. Instructions 308, consisting of individual instructions 310, also arrive at the processor. The instructions 308 may be, for example, x86 instructions and the SISD processor 302 may be an x86 processor. The result of the SISD processing is a single result stream consisting of results 314.

The SIMD processor 316 is able to receive multiple data streams 318, with each data stream still including individual data elements 306. Here, four columns of four data elements each are shown coming into the SIMD processor. Instructions 320, consisting of individual instructions 322, also arrive at the processor. In this case, the instructions 322 may, for example, be SSE instructions suitable for the SIMD-capable processor 316. The result of the SISD processing is multiple result streams 324 consisting of results 314. The diagram 300 shows that many more results 314 may be processed with the SIMD processor 316 as compared with the SISD processor 302.

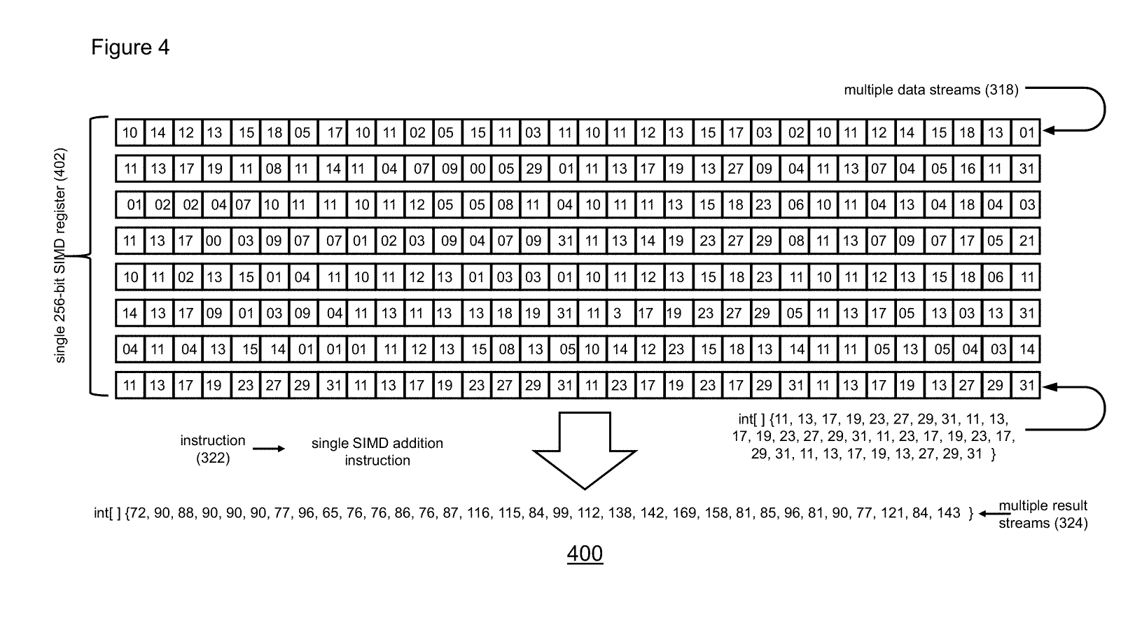

SIMD instructions allow multiple calculations to be carried out simultaneously on a single core of a processor by using a register that is multiples of the data length in size. For example, with a 256-bit register, eight 32-bit calculations may be performed using a single SIMD machine code instruction. FIG. 4 is a diagram 400 illustrating a single 265-bit SIMD register 402 containing eight 32-bit data streams 318. SIMD register 402 could be implemented in the processor 102 of device 100 discussed above. A single SIMD addition instruction generates the result shown. In essence, each data value in each column of the SIMD register 402, for a total of eight data values, is added together, and this operation is happening simultaneously 32 times (as there are 32 columns). A 32-bit result of these 32 additions of eight data elements each, shown at the bottom of the diagram 400, is the multiple result stream 324 from FIG. 3.

As FIGS. 3 and 4 demonstrate, judicious coding to exploit SIMD instructions on appropriate data sets can result in significant speed improvement. Image processing is one such dataset that can benefit by using the SIMD instruction set.

Random Sampled Convolutions

Referring back to FIGS. 1 and 2, in some embodiments, the random sampled convolutions method 200 uses a convolution filter with a non-regular shape, where the CNN designer defines the size of the receptive field and the number of contributing pixels from the field. In some embodiments, these two parameters are determined based on the SIMD architecture of the processor system (for example, device 100 in FIG. 1) upon which the CNN is to be run. The specific pixels from the total receptive field are then randomly sampled—either per channel or per layer. By using a non-usual number of contributing pixels for the convolution filter, for example, an even number, the neural network conforms to the characteristics of the platform on which it runs. In some embodiments, this maximizes the platform multi-processing capabilities and enables the CNN to perform, for example, image classification, at a rate faster than other CNNs of otherwise similar processing capability.

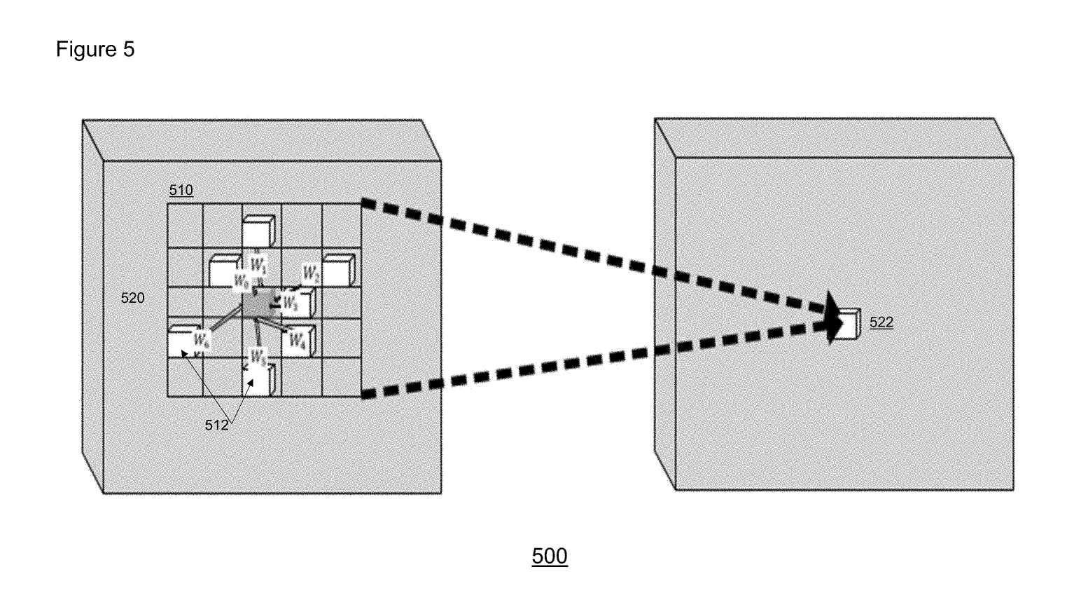

In some embodiments, the CNN designer employing the method 200 chooses arbitrarily any number of contributing pixels (known herein also as the number of learnable parameters), such as to optimize the SIMD capabilities of the platform. As described above, SIMD refers to a class of parallel computers with multiprocessing elements that perform the same operation on multiple data points simultaneously. Where the CNN is running on a SIMD platform, the CNN designer may choose a number that is optimized for the platform SIMD capabilities. FIG. 5 is an illustration 500 of a random sampled convolution, according to some embodiments. Convolution is an element-wise multiplication and sum (that is, a dot product), between the filter (kernel) and the image at each location. The image 500 shows the filter 510, with weights W 512 being multiplied by the neighborhood of a particular pixel 520, then summed to get a result 522.

For example, suppose the neural network is about to run quantized to int8 (8-bit integer with no sign) representation and the platform accelerator has SIMD capability of processing four uint8 values at the cost of a single operation. The CNN designer may select contributing pixels in multiples of four, for example 8 pixels, for a receptive field of 5×5. This enables the convolution filter to run in as little as two intrinsic operations. Or, as another example, a receptive field of size 10×10 may be specified as having 64 learnable parameters. In some embodiments, the random sampled convolutions method 200 has, in preliminary results, shown a faster convergence rate when compared to neural networks with layers having the same full receptive field or even when compared to dilated convolution, which is explained below.

In some embodiments, the method for random sampled convolutions 200 performs the following operations. First, for a specific convolutional layer, given by L, the CNN designer selects the desired filter dimensions, which determine the size of the receptive field. In some embodiments, a larger receptive fields means larger context and yields better accuracy, although a larger receptive field also means more computation. The CNN designer also selects a number of subset of indexes n, relative to the filter spanned location (that is, the receptive field). This corresponds to the number of learnable parameters 206 from FIG. 2. The number of learnable parameters 206 may be thought of as the spatial support of the filter, and is distinct from the receptive field parameter 204. In some embodiments, the number of learnable parameters 206 is selected based on the SIMD characteristics of the platform on which the CNN is to be run, such as the device 100 (FIG. 1). The receptive field parameter enables a window size to be used by the convolution filter, with a larger receptive field providing a wider “view” of the convolution filter. The learnable parameters 206, by contrast, can be selected based on the SIMD capabilities of the SUT.

For example, suppose the CNN designer decides to use a square receptive field of size 5×5, for a total of 25 pixels. The CNN designer then selects a subset of this, say, 8 pixels, with which to perform the convolution operation. In some embodiments, the selection of 8 pixels from a receptive field of 25 pixels is based on the SIMD characteristics of the platform on which the CNN is to be run. From these selections, a random n indexes out of {0, 1, . . . M} where M is the maximal index within the chosen receptive field, is made. Put another way, from the receptive field of 25 pixels, 8 pixels are selected at random.

In some embodiments, the random selection of pixels is repeated for each filter F that is to be learned (where the layer's weight shape is W×H×C×N, where W and H correspond to each filter's shape, C is determined by the output shape of the previous layer, and N is the number of the filters to be learned. Convolution filters are made up of weights and biases. The weights for each convolution filter change as they are learned while the position (arrangement) of the indices remains unchanged.

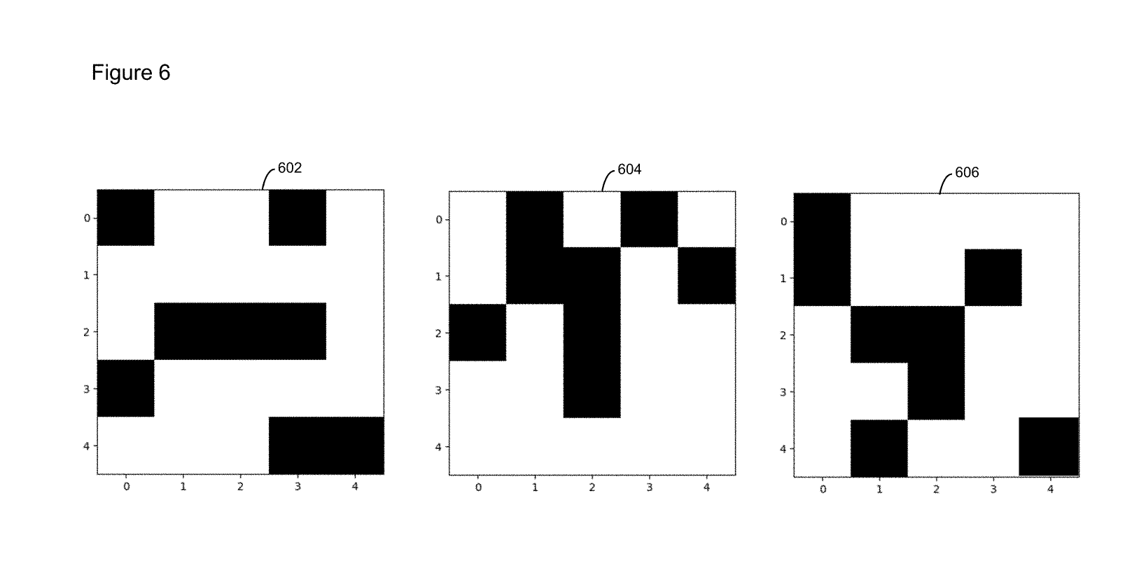

FIG. 6 is an illustration of a filter generated by the random sampled convolutions method 200 of FIG. 2, according to some embodiments. Three different receptive fields 602, 604, and 606 are shown, each of size 5×5, with eight pixels (learnable parameters) selected at random out of each receptive field. The pixels are indicated in black are the n field elements of the number of learnable parameters 206 (FIG. 2) used for the convolution filter.

The random indexes are saved as an additional constant layer's input in the network configuration file, e.g., the updated trained CNN parameters step 224 of FIG. 2. For example, the indices are defined once and they are a constant (not changing) attribute for each filter in each layer. The network configuration file stores parameters that define the configuration of the CNN. At training and inference, the saved indexes are loaded from the network configuration and the convolution operation is performed over the specified indexes. For example, the CNN designer randomizes several indexes, generating several filters such as those in FIG. 6, trains on a validation set each CNN configuration, and picks the subset of indexes (filter) that lead to the fastest convergence.

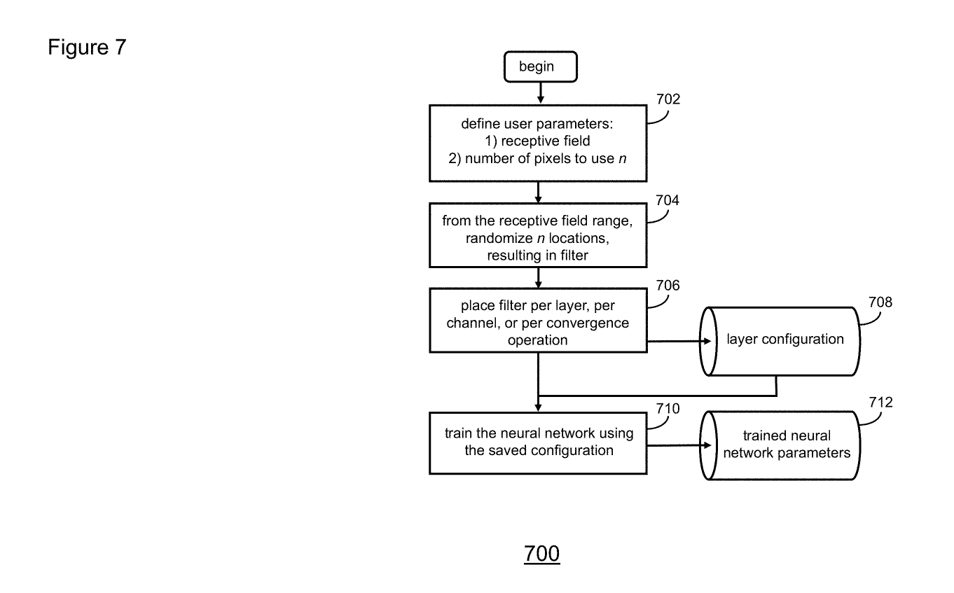

FIG. 7 is a flow chart 700 illustrating the random sampled convolutions method 200, according to some embodiments. The CNN designer parameters are defined, namely, the size of the receptive field and the number of pixels, n, to use within the receptive field (block 702). In an example, the number of pixels, n, is determined based on the SIMD characteristics of the platform upon which the CNN is to be run. From the two selections, the size of the receptive field and the n locations in the receptive field, the n locations in the receptive field are randomized, resulting in a filter (block 704). For example, for a 5×5 receptive field, the randomized filter may look something like one of the examples given in FIG. 6. The filter is then disposed at one or more locations in the convolution filter, whether at one or more layers or at one or more channels (block 706). This information is saved as part of the configuration for that convolutional layer (block 708). The CNN will learn the weights of the filters that are optimal, given the current configuration. Next, the neural network is trained using the saved configuration (block 710). Where possible, several different randomized filters are used to train the neural network, and the one that converges to the correct result fastest is saved as a trained neural network parameter (block 712).

In some embodiments, the random sampled convolutions method 200 utilizes built-in, general purpose accelerators' capability that provides improved results over other CNNs, described in the next section.

Other CNNs

Other attempts to increase the effectiveness of convolution layers without increasing the computation cost are known in the art. Dilated convolutions, also known as algorithm a trous, involves performing the convolution operation, not on the continuous signal, but using filters with holes. In regular convolution, with a dilation factor of 1, the receptive field is, for example, of size 3×3 and there are no holes. In dilated convolution, with a dilation factor of 2, the receptive field would instead be 5×5. Thus, dilated convolutions expand the filter size without increasing the number of parameters. This enables a larger receptive field while working within the same computation budget.

Perforated CNNs have been proposed to reduce the computational cost of CNN evaluation by exploiting the spatial redundancy of the network. In a fraction of the output convolution map, the output is computed in the same way as regular convolution, while the rest of the map is interpolated using nearest neighbor. The locations of the areas to be convolved vs. the areas to be interpolated are set by the perforation masks. This method decreases the runtime significantly in some cases.

Deformable convolutions enhance the transformation modeling capacity of CNNs by augmenting the spatial sampling locations in the modules. This is done by adding the 2D offset to the regular grid sampling locations and performing free-form deformation of the sampling grid. With a sampling size of 3×3, for example, in the training procedure, the layer learns the best indices of values to convolve with, within the range of three neighbors, hence enabling a receptive field of, say, 7×5. The offsets are learned from the preceding feature maps by additional convolution layers.

Active convolutions are similar to deformable convolutions, active convolutions are convolutions with shape that is learned during training. In deformable convolution, the shape is learned according to the input, that is, the preceding feature map with an extra convolution layer, while in active convolution the shape is learned directly.

There are some disadvantages to these approaches to save computation cost. Dilated convolutions simply extend the sampling grid, but do so with a fixed factor for all pixels and hence is not as flexible as the random sampled convolutions method 200, or even the deformable and active convolutions. Perforated CNNs work feature map-wise and hence are different than the random sampled convolutions method 200, which works filter-wise. Perforated CNNs also involve longer training time to learn the perforation mask while the random sampled convolutions method 200 seamlessly fit the existing training procedure and, in some embodiments, make the convergence happen sooner. Deformable convolutions include an extra convolution layer to learn the deformation shape, which involves more computation rather than less, and deformable convolutions also allow only a fixed number of pixels to convolve. Similarly, active convolutions allow only a fixed number of pixels to convolve while the random sampled convolutions method 200, as described above, allows the user to define a non-conventional number of input pixels.

Test Results

The random sampled convolutions method 200 has been tested using a couple of well-known databases, with encouraging results. The Modified National Institute of Standards and Technology (MNIST) is a large database of handwritten digits that is commonly used for training image processing systems. The Canadian Institute for Advanced Research (CIFAR) has a database, known as CIFAR-10, which include images used for machine learning and computer vision algorithm training. Both of these databases were used to train a CNN using the random sampled convolutions method 200.

MNIST/LeNet Model:

The random sampled convolutions method 200 is trained using the MNIST database. Three CNNs were run, the original CNN, a dilated CNN, and the random sampled convolutions CNN. Table 1 shows the particulars of each CNN.

TABLE 1
Model size/Runtime:

| Model | Size (in MB) | Runtime (in MS) |
|---|---|---|
| Original | 1.7 | 34 |
| Dilated | 1.6 | 26 |
| Random sampled convolution | 1.56 | 21 |

Table 1 shows that the original model size is 1.7 MB (97% accuracy), the dilated convolution model size 1.6 MB (97% accuracy), and the random sampled convolutions approach size is 1.56 MB (98% accuracy), where the accuracy numbers reflect the percentage of digits correctly classified from a test set.

The following shows the structure of each CNN used in the test. Although activations, such as ReLU, were used, they are omitted for convenience:

Original model: convolution (using 20 5×5 filters)→pooling→convolution (using 50 5×5 filters)→pooling→inner-product (500 channels)→softmax.

Dilated model: convolution (using 20 3×3 filters, with a dilation of 2)→pooling→convolution (using 50 3×3 filters, with a dilation of 2)→pooling→inner-product (500 channels)→softmax.

Random sampled convolution method 200: convolution (20 5×5 filters, with 8 out of the 25 pixels being used)→pooling→convolution (50 5×5 filters, with 8 out of the 25 pixels being used)→pooling→inner-product (500 channels)→softmax.

In the dilation model, the size of the receptive field is smaller, but the dilation is set to two, whereas the other CNNs have dilation set to one. The random sampled convolution method 200 uses the reduced number of pixels from the receptive field, which are then randomized, as described above.

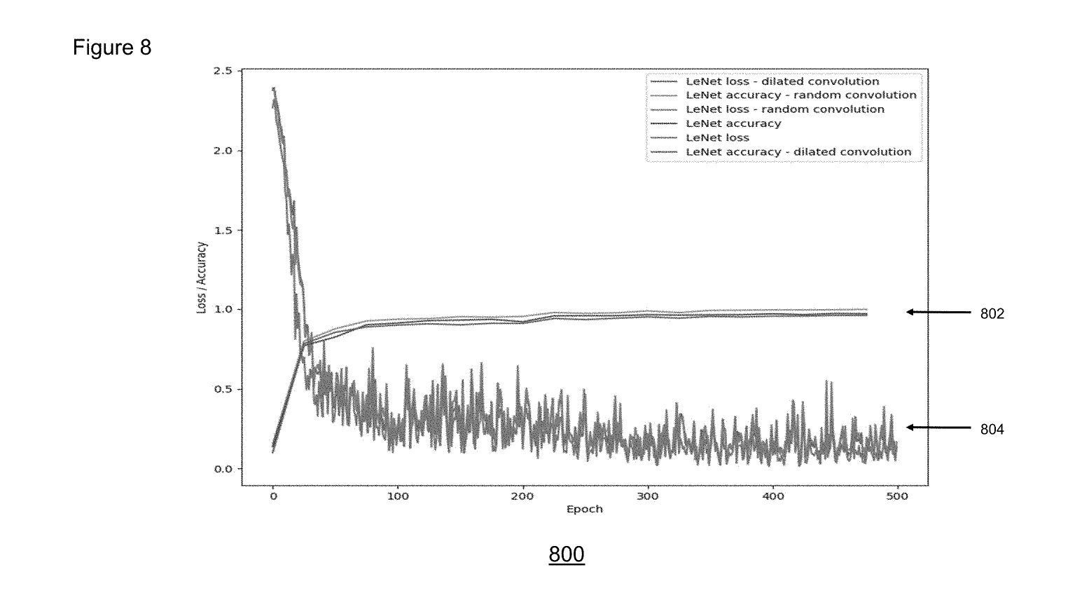

FIG. 8 is a loss/accuracy plot 800 for the three different CNNs using the MNIST database, according to some embodiments. The accuracy 802 is shown for the three networks, and all track pretty closely to one another. The loss 804 is also shown for all three networks, and again, track pretty closely to one another. When the network is being trained, if successful, the loss function is minimized.

CIFAR10:

The CIFAR-10 database include images used for machine learning and computer vision algorithm training. The random sampled convolutions method 200 is trained using the CIFAR-10 database. As before, three CNNs were run, the original CNN, a dilated CNN, and the random sampled convolutions CNN. Table 2 shows the particulars of each CNN.

TABLE 2
Model size/Runtime:

| Model | Size (in MB) | Runtime (in MS) |
|---|---|---|
| Original | 0.58 | 173 |
| Dilated | 0.38 | 94 |
| Random sampled convolution | 0.34 | 87 |

The original model size is 0.58 MB (97% accuracy), the dilated convolution model size is 0.38 MB (97% accuracy) and the random sampled convolutions 200 is 0.34 MB (98% accuracy).

Original model: convolution (32 5×5 filters)→pooling→convolution (32 5×5 filters)→pooling→convolution (64 5×5 filters)→pooling→inner-product (64 channels)→inner-product (10 channels)→softmax,

Dilated model: convolution (32 3×3 filters with a dilation of 2)→pooling→convolution (32 3×3 filters with a dilation of 2)→pooling→convolution (64 3×3 filters with a dilation of 2)→pooling→inner-product (64 channels)→inner-product (10 channels)→softmax,

Sampled convolution method 200: convolution (32 5×5 filters, with 8 out of the 25 pixels being used)→pooling→convolution (32 5×5 filters, with 8 out of the 25 pixels being used)→pooling→convolution (64 5×5 filters, with 12 out of the 25 pixels being used)→pooling→inner-product (64 channels)→inner-product (10 channels)→softmax.

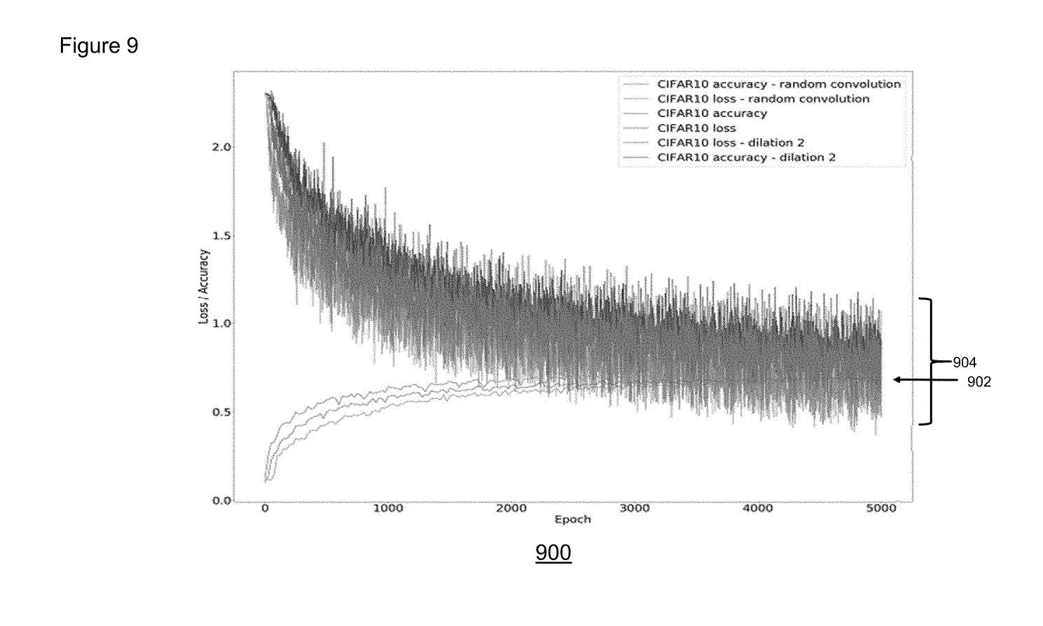

FIG. 9 is a loss/accuracy plot 900 for the three different CNNs using the CIFAR10 database, according to some embodiments. The accuracy 902 is shown for the three networks, and all track pretty closely to one another. The loss 904 is also shown for all three networks.

FIGS. 8 and 9 illustrate that the sampled convolution method 200 provides better accuracy and faster execution for MNIST/CIFAR10 while decreasing the model size. In addition to these test cases, the sampled convolution method 200 is also useful for large datasets and with more difficult problems, such as semantic segmentation, in some embodiments.

The sampled convolution method 200 also compares favorably to other CNN models described above. As compared to dilated convolution, the sampled convolution method 200 uses fewer pixels with a larger receptive field and hence allows smaller models with higher accuracy, as illustrated in the above two test examples. While perforated CNN is a conceptually different approach, the sampled convolution method 200 is more flexible and allows more pixels to be taken into account during computation, while perforated CNN ignores some of the pixels due to the fixed feature-map-wise perforation mask.

The sampled convolution method 200 also compares favorably to the deformable and active convolutions described above. With the random sampled convolution method 200, fewer pixels are used as well as a larger receptive field. Further, the sampled convolution method 200 doesn't involve learning the filter mask as do the deformable and active convolutions. Hence, for the sampled convolution method 200, the training process involves a more simplified learning task. Also, compared to these methods, the sampled convolution method 200 better utilizes the SIMD capabilities of the platform on which the CNN is run, which, in some embodiments, results in a significant decrease in runtime. Even with the existing Math Kernel Library (MKL) matrix multiplication operations, the sampled convolution method 200 provides a runtime boost without special implementation, due to the use of aligned sizes, for example, four times the number of pixels from any receptive field.

FIG. 10 illustrates an embodiment of an exemplary computing architecture 1000 comprising a computing system 1002 that may be suitable for implementing various embodiments as previously described. In various embodiments, the computing architecture 1000 may comprise or be implemented as part of an electronic device. In some embodiments, the computing architecture 1000 may be representative, for example, of a system that implements one or more components of the random sampled convolution method 200. In some embodiments, computing system 1002 may be representative, for example, of the mobile devices used in implementing the sampled convolution method 200. The embodiments are not limited in this context. More generally, the computing architecture 1000 is configured to implement all logic, applications, systems, methods, apparatuses, and functionality described herein.

As used in this application, the terms “system” and “component” and “module” are intended to refer to a computer-related entity, either hardware, a combination of hardware and software, software, or software in execution, examples of which are provided by the exemplary computing architecture 1000. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 1002 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 1002.

As shown in FIG. 10, the computing system 1002 comprises a processor 1004, a system memory 1006 and a system bus 1008. The processor 1004 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi-processor architectures may also be employed as the processor 1004. The processor 1004 may be SIMD-capable and thus suitable for implementing the random sampled convolution method 200.

The system bus 1008 provides an interface for system components including, but not limited to, the system memory 1006 to the processor 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computing system 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies. The computing system 1002 is generally is configured to implement all logic, systems, methods, apparatuses, and functionality described herein with reference to FIGS. 1-9.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the device for sampled convolutions 100, e.g., the instructions 110 and the CNN 114.

A user can enter commands and information into the computing system 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computing system 1002. In addition to the monitor 1044, a computer typically includes other peripheral output devices, such as speakers, printers, and so forth.

The computing system 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computing system 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computing system 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computing system 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computing system 1002, or portions thereof, can be stored in the remote memory/storage device 1050. It will be appreciated that the network connections shown are exemplary and other means of establishing a communications link between the computers can be used.

The computing system 1002 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

In summary, the random sampled convolution method may be implemented in a first example by an apparatus comprising a processor and a memory coupled coupled to the processor, the memory comprising instructions which, when executed by the processor, cause the processor to generate, based in part on a receptive field size and a number of learnable parameters, a plurality of filters for a convolutional neural network (CNN), each filter comprising the number of learnable parameters arranged in different random configurations on the filter, wherein the number of learnable parameters is based on a computing characteristic of the apparatus, select one filter from the plurality of filters based a convergence speed, for each of the plurality of filters, of the CNN, and train the CNN on a validation set using the filter.

Further to the first example or any other example discussed herein, in a second example, the computing characteristic is the ability of the processor to execute a Single Instruction, Multiple Data (SIMD) instruction set.

Further to the first example or any other example discussed herein, in a third example, wherein the filter is disposed in a channel of the CNN.

Further to the first example or any other example discussed herein, in a fourth example, the filter is disposed in a layer of the CNN.

Further to the first example or any other example discussed herein, in a fifth example, the receptive field size is 5×5 and the number of learnable parameters is 8.

Further to the first example or any other example discussed herein, in a sixth example, the memory comprises instructions which, when executed by the processor, cause the processor to generate, based in part on the receptive field size and a number of learnable parameters, a second filter comprising the number of learnable parameters, wherein the learnable parameters are arranged in a second configuration on the second filter, and train a second CNN on the validation set using the second filter.

Further to the sixth example or any other example discussed herein, in a seventh example, the CNN converges faster than the second CNN.

Further to the seventh example or any other example discussed herein, in an eighth example, the memory comprises instructions which, when executed by the processor, cause the processor to store the first configuration in a database.

Further, the random sampled convolution method may be implemented in a ninth example by at least one machine-readable storage medium comprising instructions that, when executed by a processor, cause the processor to define a filter dimension to be used in a convolution layer of a convolutional neural network (CNN), wherein the filter dimension determines a receptive field size of the convolutional layer, specify a number of learnable parameters based on a computing characteristic of the processor, generate a plurality of filters, each of the plurality of filters comprising the receptive field size and comprising the specified number of learning parameters, wherein the arrangement of learning parameters is distinct for each of the plurality of filters, and execute the CNN using the filter.

Further to the ninth example or any other example discussed herein, in a tenth example, the at least one machine-readable storage medium comprises instructions that further cause the processor to specify the number of learnable parameters based on a Single Instruction, Multiple Data (SIMD) computing characteristic of the processor.

Further to the ninth example or any other example discussed herein, in an eleventh example, the at least one machine-readable storage medium comprises instructions that further cause the processor to use one of the plurality of filters in a channel of the CNN, and use a second of the plurality of filters in a layer of the CNN.

Further to the ninth example or any other example discussed herein, in a twelfth example, the at least one machine-readable storage medium comprises instructions that further cause the processor to select one of the plurality of filters based on which one converges the fastest when running the CNN.

Further to the ninth example or any other example discussed herein, in a thirteenth example, the at least one machine-readable storage medium comprises instructions that further cause the processor to use the filter to perform training and inference of the CNN.

The random sampled convolution method may be implemented in a fourteenth example by an apparatus comprising a multi-processor supporting execution of a Single Instruction Multiple Data (SIMD) instruction set, a SIMD register to be used when executing the SIMD instruction set, a memory coupled to the multi-processor, the memory comprising instructions which, when executed by the multi-processor, cause the multi-processor to generate a filter based on a receptive field size and a number of learnable parameters, the number of learnable parameters being arranged in a first configuration, wherein the number of learnable parameters is based on the SIMD instruction set, and embed the filter in a channel of an CNN, the CNN comprising a plurality of channels, wherein the CNN is executed by the multi-processor using the filter and the SIMD instruction set.

Further to the fourteenth example or any other example discussed herein, in a fifteenth example, the memory of the apparatus further comprises instructions which, when executed by the multi-processor, cause the multi-processor to generate a plurality of filters based on the receptive field size and the number of learnable parameters, the number of learnable parameters being arranged in a second configuration in one filter of the plurality of filters, wherein the first configuration is different from the second configuration, and embed the one filter in a second channel of the CNN.

Further to the fifteenth example or any other example discussed herein, in a sixteenth example, the memory of the apparatus further comprises instructions which, when executed by the multi-processor, cause the multi-processor to embed a second filter of the plurality of filters in a layer of the CNN, the number of learnable parameters being arranged in a third configuration of the second filter, wherein the third configuration is different from the first configuration and the second configuration.

Further to the sixteenth example or any other example discussed herein, in a seventeenth example, the memory of the apparatus further comprises instructions which, when executed by the multi-processor, cause the multi-processor to select either the first filter, the second filter, or the third filter based on how fast the CNN converges with each filter.

Further to the fourteenth example or any other example discussed herein, in an eighteenth example, the receptive field size is 5×5 and the number of learnable parameters is 8.

Further to the fourteenth example or any other example discussed herein, in a nineteenth example, the receptive field size is 10×10 and the number of learnable parameters is 64.

Further to the seventeenth example or any other example discussed herein, in a twentieth example, the receptive field size and number of learnable parameters of the selected filter are saved in a database.

Some embodiments may be described using the expression “one embodiment” or “an embodiment” along with their derivatives. These terms mean that a feature, structure, or characteristic described relating to the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, various features are grouped together in a single embodiment for streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the Plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided herein are not intended to be limiting.

1. An apparatus comprising:
a processor; and
memory coupled to the processor, the memory comprising instructions which, when executed by the processor, cause the processor to:
generate, based in part on a receptive field size and a number of learnable parameters, a plurality of filters for a convolutional neural network (CNN), each filter comprising the number of learnable parameters arranged in different random configurations on the filter, wherein the number of learnable parameters is based on a computing characteristic of the apparatus;
select one filter from the plurality of filters based on a convergence speed, for each of the plurality of filters, of the CNN; and
train the CNN on a validation set using the one filter from the plurality of filters.

2. The apparatus of claim 1, wherein the computing characteristic is the ability of the processor to execute a Single Instruction, Multiple Data (SIMD) instruction set.

3. The apparatus of claim 1, wherein the filter is disposed in a channel of the CNN.

4. The apparatus of claim 1, wherein the filter is disposed in a layer of the CNN.

5. The apparatus of claim 1, wherein the receptive field size is 5×5 and the number of learnable parameters is 8.

6. The apparatus of claim 1, the memory comprising instructions which, when executed by the processor, cause the processor to:
generate, based in part on the receptive field size and the number of learnable parameters, a second filter comprising the number of learnable parameters, wherein the learnable parameters are arranged in a second configuration on the second filter; and
train a second CNN on the validation set using the second filter.

7. The apparatus of claim 6, wherein the second CNN converges faster than the CNN.

8. The apparatus of claim 7, the memory comprising instructions which, when executed by the processor, cause the processor to store the second configuration in a database.

9. At least one machine-readable storage medium comprising instructions that, when executed by a processor, cause the processor to:
define a filter dimension to be used in a convolution layer of a convolutional neural network (CNN), wherein the filter dimension determines a receptive field size of the convolutional layer;
specify a number of learnable parameters based on a computing characteristic of the processor;
generate a plurality of filters, each of the plurality of filters comprising the receptive field size and comprising the specified number of learning parameters, wherein the arrangement of learning parameters is distinct for each of the plurality of filters; and
execute the CNN using the filter.

10. The at least one machine-readable storage medium of claim 9, comprising instructions that further cause the processor to specify the number of learnable parameters based on a Single Instruction, Multiple Data (SIMD) computing characteristic of the processor.

11. The at least one machine-readable storage medium of claim 9, comprising instructions that further cause the processor to:
use one of the plurality of filters in a channel of the CNN; and
use a second of the plurality of filters in a layer of the CNN.

12. The at least one machine-readable storage medium of claim 9, comprising instructions that further cause the processor to select one of the plurality of filters based on which one converges the fastest when running the CNN.

13. The at least one machine-readable storage medium of claim 9, comprising instructions that further cause the processor to use the filter to perform training and inference of the CNN.

14. An apparatus comprising:
a multi-processor supporting execution of a Single Instruction Multiple Data (SIMD) instruction set;
a SIMD register to be used when executing the SIMD instruction set;
a memory coupled to the multi-processor, the memory comprising instructions which, when executed by the multi-processor, cause the multi-processor to:
generate a filter based on a receptive field size and a number of learnable parameters, the number of learnable parameters being arranged in a first configuration, wherein the number of learnable parameters is based on the SIMD instruction set; and
embed the filter in a channel of a convolutional neural network (CNN), the CNN comprising a plurality of channels, wherein the CNN is executed by the multi-processor using the filter and the SIMD instruction set.

15. The apparatus of claim 14, the memory further comprising instructions which, when executed by the multi-processor, cause the multi-processor to:
generate a plurality of filters based on the receptive field size and the number of learnable parameters, the number of learnable parameters being arranged in a second configuration in one filter of the plurality of filters, wherein the first configuration is different from the second configuration; and
embed the one filter in a second channel of the CNN.

16. The apparatus of claim 15, the memory further comprising instructions which, when executed by the multi-processor, cause the multi-processor to:
embed a second filter of the plurality of filters in a layer of the CNN, the number of learnable parameters being arranged in a third configuration of the second filter, wherein the third configuration is different from the first configuration and the second configuration.

17. The apparatus of claim 16, the memory further comprising instructions which, when executed by the multi-processor, cause the multi-processor to:
select either the first filter, the second filter, or the third filter based on how fast the CNN converges with each filter.

18. The apparatus of claim 14, wherein the receptive field size is 5×5 and the number of learnable parameters is 8.

19. The apparatus of claim 14, wherein the receptive field size is 10×10 and the number of learnable parameters is 64.

20. The apparatus of claim 17, wherein the receptive field size and number of learnable parameters of the selected filter are saved in a database.
